(19) United States
(12) Patent Application Publication
(10) Pub. No.: US 2026/0228426 A1
(43) Pub. Date: Aug. 6, 2026

(54) MACHINE LEARNING-BASED GENERATION OF SOLUTION TREES FOR ISSUES IN AN INFORMATION TECHNOLOGY INFRASTRUCTURE

(71) Applicant: Dell Products L.P., Round Rock, TX (US)

(72) Inventors: Asish Pradhan, Round Rock, TX (US); Malak Alshawabkeh, Franklin, MA (US); Anmol Dubey, Renukoot (IN); Victoria Alexis Young, San Antonio, TX (US); Sathisha B. Prabhu, Bangalore (IN)

(21) Appl. No.: 19/043,875

(22) Filed: Feb. 3, 2025

(51) Int. Cl. G06F 40/20

(52) U.S. Cl. CPC G06F 40/20

(57) ABSTRACT

An apparatus comprises at least one processing device configured to obtain a natural language description of issues associated with an information technology infrastructure, to process, utilizing a machine learning model, the natural language description and data structures characterizing content of pre-built solution trees for historical issues, and to generate a solution tree for the issues utilizing at least one pre-built solution tree selected based on an output of the machine learning model as a template, the generated solution tree comprising a graphical representation of steps for achieving potential solutions to the issues. The at least one processing device is further configured to associate the generated solution tree with at least a subset of information technology assets of the information technology infrastructure, and to utilize the generated solution tree for diagnosing and remediating the issues on the subset of the information technology assets.

### BACKGROUND

Support platforms may be utilized to provide various services for sets of managed computing devices. Such services may include, for example, troubleshooting and remediation of issues encountered on computing devices managed by a support platform. This may include periodically collecting information on the state of the managed computing devices, and using such information for troubleshooting and remediation of the issues. Such troubleshooting and remediation may include receiving requests to provide servicing of hardware and software components of computing devices. For example, users of computing devices may submit service requests to a support platform to troubleshoot and remediate issues with hardware and software components of computing devices. Such requests may be for servicing under a warranty or other type of service contract offered by the support platform to users of the computing devices.

### SUMMARY

Illustrative embodiments of the present disclosure provide techniques for machine learning-based generation of solution trees for issues in an information technology infrastructure.

In one embodiment, an apparatus comprises at least one processing device comprising a processor coupled to a memory. The at least one processing device is configured to obtain a natural language description of one or more issues associated with an information technology infrastructure and to process, utilizing at least one machine learning model, the natural language description of the one or more issues and at least portions of one or more data structures characterizing content of one or more pre-built solution trees for one or more historical issues. The at least one processing device is also configured to select, based at least in part on an output of the at least one machine learning model, at least a portion of at least one of the one or more pre-built solution trees and to generate a solution tree for the one or more issues utilizing the selected at least a portion of at least one of the one or more pre-built solution trees as a template, the generated solution tree comprising a graphical representation of different potential solutions to the one or more issues and steps for achieving each of the different potential solutions. The at least one processing device is further configured to associate the generated solution tree with at least a subset of a plurality of information technology assets of the information technology infrastructure, and to utilize the generated solution tree for at least one of diagnosing and remediating instances of the one or more issues encountered on the subset of the plurality of information technology assets of the information technology infrastructure.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based generation of solution trees for issues in an information technology infrastructure in an illustrative embodiment.

FIG. 2 is a flow diagram of an exemplary process for machine learning-based generation of solution trees for issues in an information technology infrastructure in an illustrative embodiment.

FIG. 3 shows an example solution tree data structure in an illustrative embodiment.

FIG. 4 shows another example solution tree data structure in an illustrative embodiment.

FIG. 5 shows pseudocode for an algorithm for generating a content-based recommender system in an illustrative embodiment.

FIG. 6 shows a system flow for solution tree data structure generation in an illustrative embodiment.

FIG. 7 shows an interface of a platform configured for automated generation of a solution tree data structure in an illustrative embodiment.

FIG. 8 shows a matrix of metrics for values of a pre-built solution tree data structure in an illustrative embodiment.

FIG. 9 shows a tag similarity plot in an illustrative embodiment.

FIGS. 10A-10D show views of an interface of a platform configured for automated generation of a solution tree data structure in an illustrative embodiment.

FIGS. 11 and 12 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

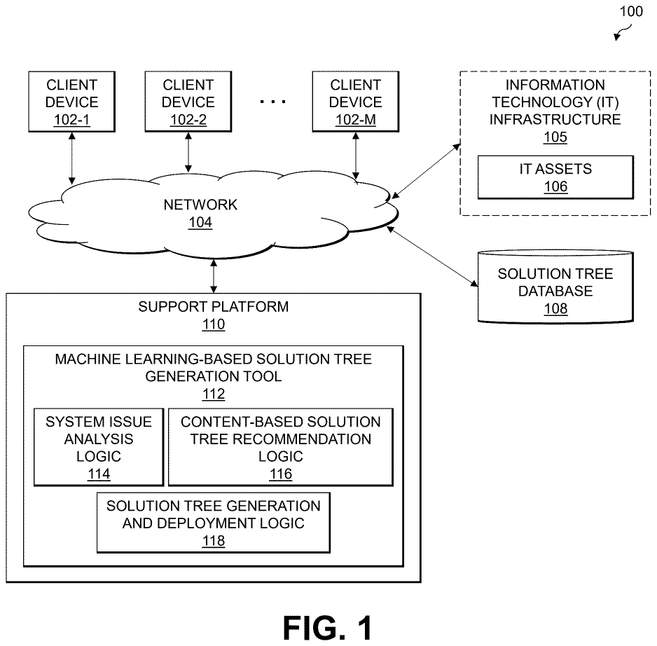

FIG. 1 shows an information processing system 100 configured in accordance with an illustrative embodiment. The information processing system 100 is assumed to be built on at least one processing platform and provides functionality for machine learning-based generation of solution trees for issues associated with an information technology (IT) infrastructure. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a solution tree database 108, and a support platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the support platform 110 is used for an enterprise system. For example, an enterprise may subscribe to or otherwise utilize the support platform 110 for managing a set of IT assets, such as the IT assets 106 of the IT infrastructure 105. For example, users of the client devices 102 may utilize the support platform 110 to generate solution tree data structures (also referred to herein as “solution trees” or “workflows”) used for remediating system issues encountered on the IT assets 106. It should be noted that, in some cases, a solution tree data structure may be a combination of multiple solution trees (e.g., each characterizing a sequence of steps for one potential solution), a combination of portions of multiple solution trees, etc. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The solution tree database 108 is configured to store and record various information that is utilized by the support platform 110 and the client devices 102. Such information may include, for example, information that is collected regarding operation of the IT assets 106 of the IT infrastructure 105 (e.g., including issues encountered thereof, results of analysis and remediation of such issues using solution tree data structures, etc.), pre-built solution tree data structures, term frequency-inverse document frequency (TF-IDF) metrics for the pre-built solution tree data structures, similarity matrixes or other data structures characterizing the TF-IDF metrics for the pre-build solution tree data structures, etc. The solution tree database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the support platform 110, as well as to support communication between the support platform 110 and other related systems and devices not explicitly shown.

The support platform 110 may be provided as a cloud service that is accessible by one or more of the client devices 102 to allow users thereof to perform issue analysis and remediation for the IT assets 106 of the IT infrastructure 105, where such issue analysis and remediation may include the generation and utilization of solution tree data structures utilizing the machine learning-based solution tree generation tool 112. In some embodiments, the client devices 102 are assumed to be associated with software developers, system administrators, IT managers or other authorized personnel responsible for managing the IT assets 106 of the IT infrastructure 105. In some embodiments, the IT assets 106 of the IT infrastructure 105 are owned or operated by the same enterprise that operates the support platform 110. In other embodiments, the IT assets 106 of the IT infrastructure 105 may be owned or operated by one or more enterprises different than the enterprise which operates the support platform 110 (e.g., a first enterprise provides support functionality for multiple different customers, businesses, etc.). Various other examples are possible.

In some embodiments, the client devices 102 and/or the IT assets 106 of the IT infrastructure 105 may implement host agents that are configured for automated transmission of information with the solution tree database 108 and the support platform 110 (e.g., regarding system issues encountered while operating the IT assets 106 of the IT infrastructure 105, creation and utilization of solution tree data structures for the system issues encountered while operating the IT assets 106 of the IT infrastructure 105, etc.). It should be noted that a “host agent” as this term is generally used herein may comprise an automated entity, such as a software entity running on a processing device. Accordingly, a host agent need not be a human entity.

The support platform 110 in the FIG. 1 embodiment is assumed to be implemented using at least one processing device. Each such processing device generally comprises at least one processor and an associated memory, and implements one or more functional modules or logic for controlling certain features of the support platform 110. In the FIG. 1 embodiment, the support platform 110 implements the machine learning-based solution tree generation tool 112. The machine learning-based solution tree generation tool 112 comprises system issue analysis logic 114, content-based solution tree recommendation logic 116 and solution tree generation and deployment logic 118. The machine learning-based solution tree generation tool 112 may be configured to provide a graphical user interface (GUI) that is accessible to authorized users of the client devices 102. Such users may access the GUI of the machine learning-based solution tree generation tool 112 to author and provide feedback related to solution tree data structures (e.g., which may be stored in the solution tree database 108). When authoring or creating a solution tree data structure, the user inputs a system issue description which is analyzed by the system issue analysis logic 114 (e.g., to generate TF-IDF metrics based on the content of the system issue description, tags which are selected by the user, etc.). The content-based solution tree recommendation logic 116 is configured to determine, utilizing a content-based machine learning recommender model that is conditioned based on the input system issue description, a set of one or more pre-built or existing solution tree data structures that exhibit a threshold similarity to the input system issue description (e.g., through comparison of TF-IDF metrics generated for the input system issue description and matrices of TF-IDF metrics generated for the pre-built solution tree data structures). The solution tree generation and deployment logic 118 is configured to select one of the set of one or more pre-built or existing solution tree data structures (e.g., based on user input, or automatically based on the similarity calculations), and to determine when and on which IT assets 106 of the IT infrastructure 105 that the selected solution tree data structure should be deployed on. The solution tree generation and deployment logic 118 also enables customization of the selected solution tree data structure (e.g., through addition/removal of nodes representing steps or actions in a solution tree or workflow, changing the connections between nodes representing the sequence that the steps or actions in the solution tree or workflow are to be taken). The machine learning-based solution tree generation tool 112 then deploys the selected solution tree data structure (e.g., which may be one of the set of one or more pre-built or existing solution tree data structures, or a customized version thereof) on one or more of the IT assets 106 of the IT infrastructure 105 to perform system issue analysis and remediation.

At least portions of the machine learning-based solution tree generation tool 112, the system issue analysis logic 114, the content-based solution tree recommendation logic 116 and the solution tree generation and deployment logic 118 may be implemented at least in part in the form of software that is stored in memory and executed by a processor.

It is to be appreciated that the particular arrangement of the client devices 102, the IT infrastructure 105, the solution tree database 108 and the support platform 110 illustrated in the FIG. 1 embodiment is presented by way of example only, and alternative arrangements can be used in other embodiments. As discussed above, for example, the support platform 110 (or portions of components thereof, such as one or more of the machine learning-based solution tree generation tool 112, the system issue analysis logic 114, the content-based solution tree recommendation logic 116 and the solution tree generation and deployment logic 118) may in some embodiments be implemented internal to the IT infrastructure 105.

The support platform 110 and other portions of the information processing system 100, as will be described in further detail below, may be part of cloud infrastructure.

The support platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the solution tree database 108 and the support platform 110 or components thereof (e.g., the machine learning-based solution tree generation tool 112, the system issue analysis logic 114, the content-based solution tree recommendation logic 116 and the solution tree generation and deployment logic 118) may be implemented on respective distinct processing platforms, although numerous other arrangements are possible. For example, in some embodiments at least portions of the support platform 110 and one or more of the client devices 102, the IT infrastructure 105, the IT assets 106 and/or the solution tree database 108 are implemented on the same processing platform. A given client device (e.g., 102-1) can therefore be implemented at least in part within at least one processing platform that implements at least a portion of the support platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the solution tree database 108 and the support platform 110, or portions or components thereof, to reside in different data centers. Numerous other distributed implementations are possible. The support platform 110 can also be implemented in a distributed manner across multiple data centers.

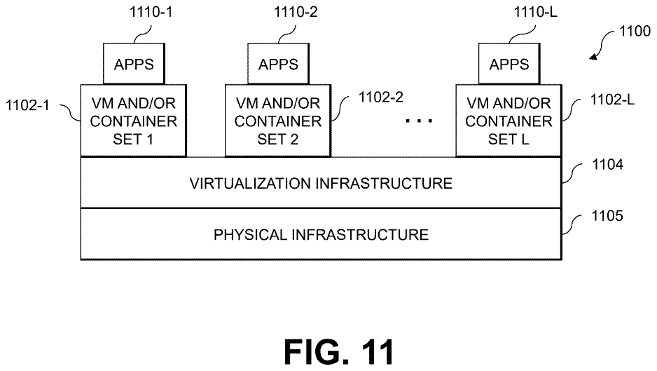

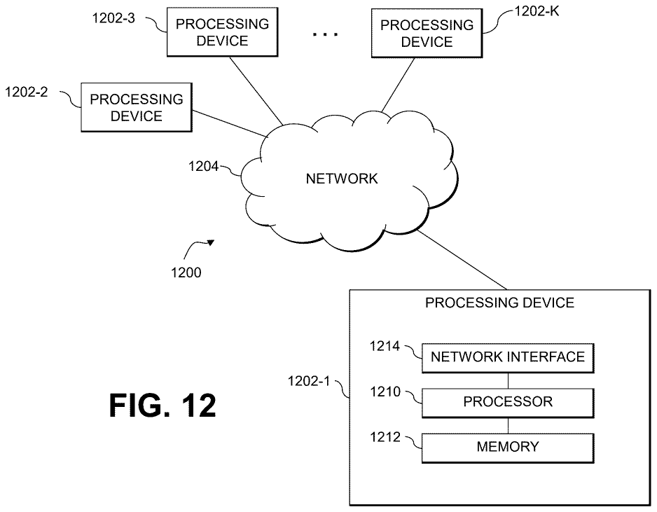

Additional examples of processing platforms utilized to implement the support platform 110 and other components of the information processing system 100 in illustrative embodiments will be described in more detail below in conjunction with FIGS. 11 and 12.

It is to be understood that the particular set of elements shown in FIG. 1 for machine learning-based generation of solution trees for issues in an IT infrastructure is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

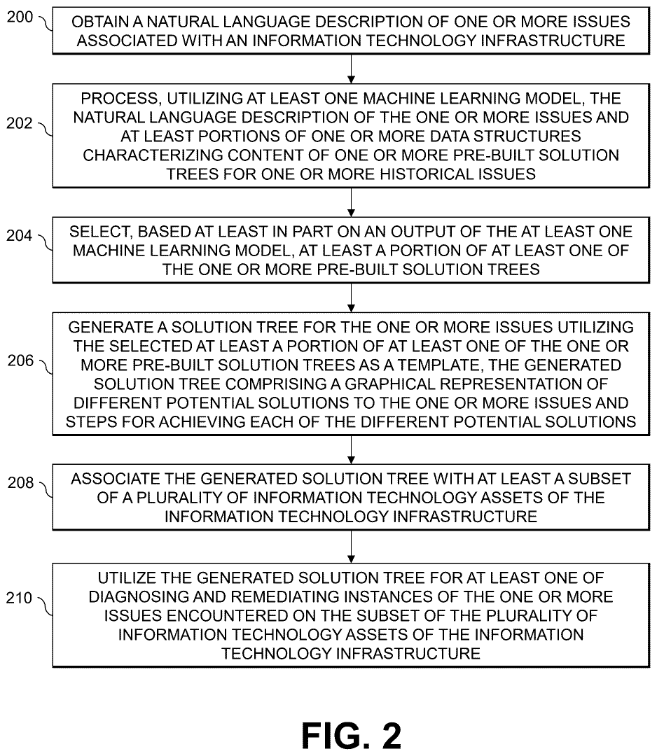

An exemplary process for machine learning-based generation of solution trees for issues in an IT infrastructure will now be described in more detail with reference to the flow diagram of FIG. 2. It is to be understood that this particular process is only an example, and that additional or alternative processes for machine learning-based generation of solution trees for issues in an IT infrastructure may be used in other embodiments.

In this embodiment, the process includes steps 200 through 210. These steps are assumed to be performed by the support platform 110 utilizing the machine learning-based solution tree generation tool 112, the system issue analysis logic 114, the content-based solution tree recommendation logic 116 and the solution tree generation and deployment logic 118. The process begins with step 200, obtaining a natural language description of one or more issues associated with an IT infrastructure.

In step 202, the natural language description of the one or more issues and at least portions of one or more data structures characterizing content of one or more pre-built solutions trees for one or more historical issues are processed utilizing at least one machine learning model. The at least one machine learning model may comprise a content-based recommendation model configured to determine similarity metrics between a first set of values associated with the one or more issues and one or more second sets of values for terms associated with the one or more pre-built solution trees. The similarity metrics may comprise cosine similarity metrics. The first and second sets of values may comprise term frequency-inverse document frequency (TF-IDF) scores. The one or more second sets of values may comprise matrices of values characterizing terms in nodes of the one or more pre-built solution trees of the one or more historical issues. The first set of values may comprise values for terms in one or more semantic tags which are dynamically associated with the one or more issues, and the one or more second sets of values may comprise values for terms in one or more semantic tags which are associated with the one or more pre-built solution trees. The one or more second sets of values may be dynamically updated based at least in part on user feedback regarding effectiveness of the one or more pre-built solution trees in at least one of diagnosing and remediating the one or more historical issues. The one or more second sets of values may comprise one or more values determined based at least in part on knowledge base articles associated with the one or more historical issues.

At least a portion of at least one of the one or more pre-built solution trees is selected based at least in part on an output of the at least one machine learning model in step 204. A solution tree for the one or more issues is generated in step 206 utilizing the selected at least a portion of at least one of the one or more pre-built solution trees as a template. The generated solution tree comprises a graphical representation of different potential solutions to the one or more issues and steps for achieving each of the different potential solutions. The generated solution tree may comprise a plurality of nodes and edges connecting the nodes, each of the plurality of nodes representing one of the steps and the edges representing sequences of the steps for achieving the different potential solutions. Step 206 may comprise utilizing the selected at least a portion of at least one of the one or more pre-built solution trees as the generated solution tree. Step 206 may also or alternatively comprise modifying one or more nodes and edges in the selected at least a portion of at least one of the one or more pre-built solution trees and/or inserting one or more additional nodes and edges to the selected at least a portion of at least one of the one or more pre-built solution trees. The one or more additional nodes and edges may be identified utilizing the at least one machine learning model.

The generated solution tree is associated with at least a subset of a plurality of IT assets of the IT infrastructure in step 208. Step 208 may comprise specifying a schedule for executing the generated solution tree on the subset of the plurality of IT assets of the IT infrastructure. The generated solution tree is utilized in step 210 for at least one of diagnosing and remediating instances of the one or more issues encountered on the subset of the plurality of IT assets of the IT infrastructure.

It should be noted that the term “data structure” as used herein is intended to be broadly construed. A data structure, such as any single one of or combination of the data structures referred to above, may provide a portion of a larger data structure, or any one of or combination of the data structures may be combinations of multiple smaller data structures. Therefore, the data structures referred to above may be different parts of a same overall data structure, or one or more of the data structures could be made up of multiple smaller data structures. The data structures may include tables, vectors, embeddings, or various other data structures. In some embodiments, the data structures are specifically formatted or generated such that they are suitable for use as at least one of an input to and an output from a machine learning model. It should further be appreciated that “generating” a data structure may encompass, for example, populating a previously-created data structure.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

A remediation platform or other type of support platform can enable IT administrators or other users to create solution tree data structures, also referred to as “solution trees” or “workflows,” and to designate target IT assets (e.g., devices, such as computer laptops, desktops, servers, IoT devices, etc.) where such solution trees or workflows are to be executed. A solution tree or workflow may be used in the context of decision-making processes or problem solving, and may include a graphical representation of different potential solutions to a problem and the steps required to achieve a solution to the problem. The graphical representation may comprise a tree structure, where each node in the tree represents a step or decision, and the connections between the nodes represent the sequence or dependencies of the steps. The solution tree or workflow provides a structured approach to exploring multiple solution pathways, and helps in selecting the most effective or efficient solution to a problem.

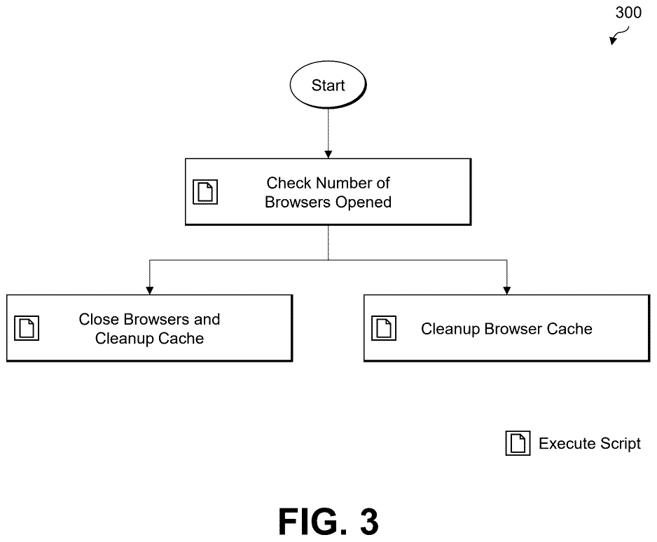

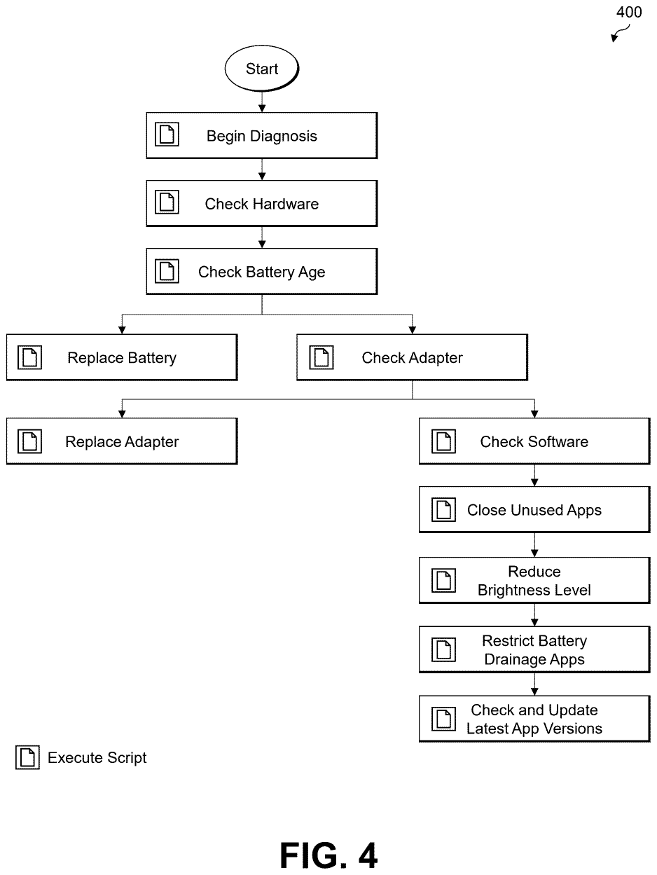

Conventional approaches for developing solution trees or workflow for various system issues can be time-consuming and error-prone, as they are often done manually. This process relies heavily on an IT administrator or other user's knowledge and expertise as well as numerous knowledge base articles, which presents a risk of creating inaccurate workflows and, consequently, incorrect solutions to system issues. In addition, as the number of nodes and levels in a solution tree increases, the complexity of creating an accurate and efficient solution tree also rises, exacerbating the potential for errors and inefficiencies. FIG. 3 shows a solution tree data structure 300 for a workflow for addressing a system issue of “Browser slowness in remote system.” The solution tree data structure 300 includes a “start” node, followed by a sequence of nodes each associated with an executable script (e.g., a PowerShell script) for automated execution of its associated action (e.g., checking the number of browsers opened, and then either closing browsers and cleaning up the cache or cleaning up the browser cache). FIG. 4 shows another solution tree data structure 400 for a workflow for addressing the system issue of “Battery draining quickly.” The solution tree data structure 400 similarly includes a “start” node, followed by a sequence of nodes each associated with an executable script (e.g., a PowerShell Script) for automated execution of its associated action (e.g., begin diagnosis, check hardware, check battery age then either replace battery or check adapter, then either replace adapter or check software, close unused applications, reduce brightness level, restrict battery draining applications, and check and update to latest application versions).

Illustrative embodiments provide technical solutions for automated generation of solution tree data structures, which leverage dynamic tagging functionality, a feedback loop and iterative workflows. The technical solutions described herein are configured to generate tags for solution trees or workflows dynamically, based on recurring patterns in document-user interactions. This creates metadata that evolves over time to stay context-sensitive. The technical solutions described herein are further configured to implement feedback processes that not only fine-tune similarity thresholds (e.g., for cosine similarity or other desired similarity measures or metrics) but also update TF-IDF vectors based on user input, making the system self-optimizing. The technical solutions described herein also enable the iterative workflow through a framework that learns and adapts from user interactions while addressing the specific needs of IT processes.

In some embodiments, the construction of solution trees or workflows in a remediation or other support platform utilizes the following steps:
1. Analyze and collect historical data of system issues and corresponding resolutions. Let D={d₁, d₂, . . . , d_{N}} be the collection of historical data of system issues, and their corresponding solution tree or workflow steps along with their outcomes and contextual data (e.g., where context is derived from the structure of a given solution tree or workflow). Let T={t₁, t₂, . . . , t_{N}} be the extracted terms and features, such as problem type, steps taken, time to resolution, success rate, etc. Each dⱼ is represented as a vector in an n-dimensional vector space, dⱼ={w₁ⱼ, w₂ⱼ, w₃ⱼ . . . , wₙⱼ}, where wₖⱼ is the weight for term wₖ in dⱼ. Let D̅ be the recommended solution tree or workflow.
2. Train a content-based recommender system.
3. Use \hat{D} to suggest pre-built solution trees/workflow or templates for common system issues.
4. Record user feedback and update D and T.
5. Return to step 1, and repeat until an error ε is minimized.

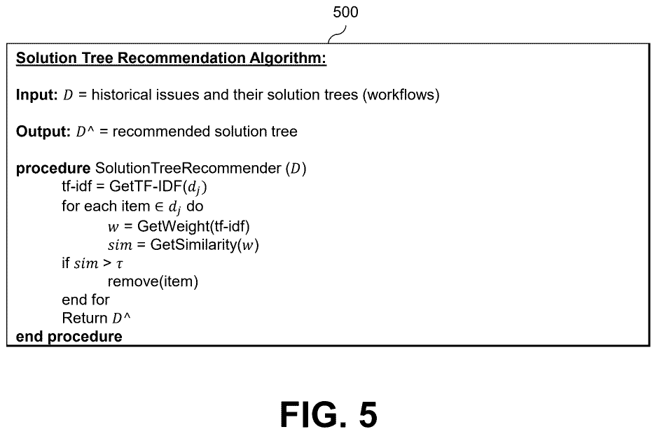

FIG. 5 shows pseudocode 500 of an algorithm for building the content-based recommender (e.g. Step 4 in the above process). This algorithm includes utilization of TF-IDF metrics, which are determined according to:

$$TF - IDF ( {t}_{k} , {d}_{j} ) = T F ( {t}_{k} , {d}_{j} ) * log \frac{N}{{n}_{k}}$$

where TF(tₖ, dⱼ) is the term frequency component, and

$$log \frac{N}{{n}_{k}}$$

is the inverse document frequency component. The weights may be calculated according to:

$${w}_{k , j} = \frac{TF - IDF ( {t}_{k} , {d}_{j} )}{\sqrt{{\sum }_{s = 1}^{\vert T \vert} TF - {IDF ( {t}_{s} , {d}_{j} )}^{2}}}$$

The similarity measure, sim, may be calculated according to:

$$sim ( {d}_{i} , {d}_{j} ) = \frac{{\sum }_{k} {w}_{k i} * {w}_{k j}}{\sqrt{{\sum }_{k} {w}_{ki}^{2}} * \sqrt{{\sum }_{k} {w}_{kj}^{2}}}$$

τ denotes a configurable similarity threshold.

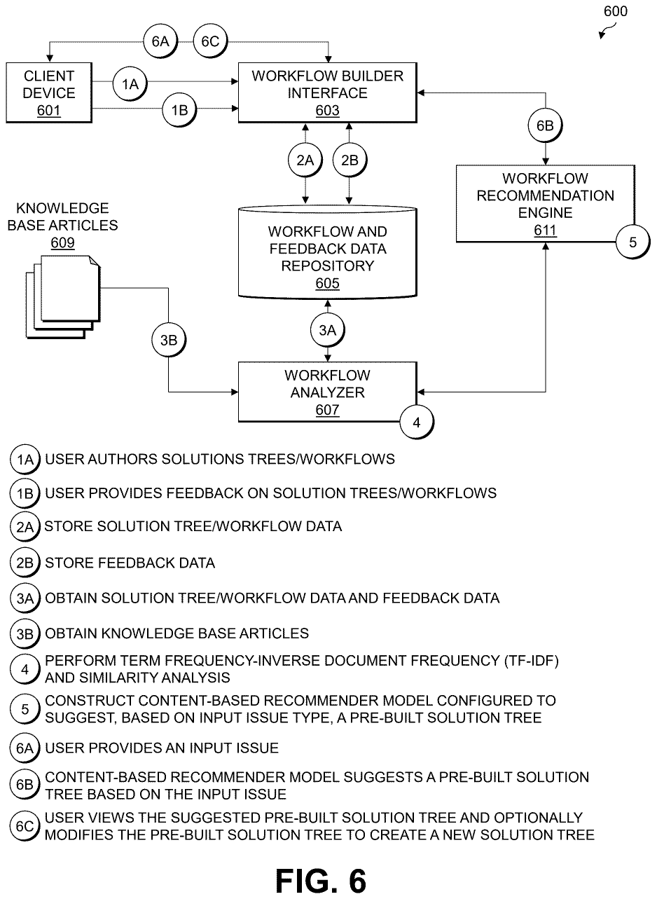

FIG. 6 shows a system flow 600 for automated solution tree data structure generation, including a client device 601 (e.g., utilized by an IT administrator or other user), a workflow builder interface 603 (e.g., a graphical user interface (GUI) that the user of the client device 601 interacts with to create/edit solution trees or workflows), a workflow and feedback data repository 605, a workflow analyzer 607, knowledge base articles 609, and a workflow recommendation engine 611. The system flow 600 includes the following steps:
1A. A user (e.g., of the client device 601) authors solution trees or workflows, and provides details of the system issues associated with the authored solution trees or workflows through “tagging” the authored solution trees or workflows (e.g., selecting from a plurality of existing tags, creating one or more custom tags, etc.) in the workflow builder interface 603.
1B. The user (e.g., of the client device 601) provides feedback on the authored solution trees or workflows (e.g., how helpful the authored solution trees or workflows are at resolving system issues).
2A. The workflow data (e.g., from Step 1A) for the authored solution trees is stored in the workflow and feedback data repository 605.
2B. The feedback data (e.g., from Step 1B) for the authored solution trees is stored in the workflow and feedback data repository 605.
3A. The workflow analyzer 607 obtains the workflow and feedback data from the workflow and feedback data repository 605.
3B. The workflow analyzer 607 obtains data from external sources, such as knowledge base articles 609.
4. The workflow analyzer 607 utilizes the obtained data (e.g., from Steps 3A and 3B) to calculate TF-IDF measures and a similarity matrix.
5. The workflow recommendation engine 611 uses the TF-IDF measures and the similarity matrix (e.g., calculated in Step 3) to construct a content-based recommender model. The content-based recommender model is configured to suggest, based on an input system issue, a pre-built solution tree or workflow (e.g., as a template which may be modified to create a new solution tree or workflow, if desired).
6A. The user (e.g., of the client device 601) seeks to create a solution tree/workflow in the workflow builder interface 603, and provides an input system issue.
6B. The workflow builder interface 603 queries the workflow recommendation engine 611 with the input system issue, and the workflow recommendation engine 611 uses the content-based recommender model (e.g., constructed in Step 5) to suggest or recommend a pre-built solution tree or workflow. This may include suggesting or recommending a set of pre-built solution trees or workflows (e.g., a top-5 or other desired number of “similar” solution trees or workflows as determined by the content-based recommender model).
6C. The user (e.g., of the client device 601) interacts with the workflow builder interface 603 to view the recommended pre-built solution trees or workflows. The user may also utilize the workflow builder interface 603 to modify or edit a selected one of the recommended pre-built solution trees or workflows (e.g., to create a new, custom solution tree or workflow). The user may optionally select particular IT assets on which to deploy or utilize solution trees or workflows, as well as a schedule for such deployment or utilization of the solution trees or workflows.

Creating multi-level solution trees or workflows, using conventional manual approaches, is tedious and error-prone and relies on having IT administrators or other users with extensive experience. Such users must determine the sequence and structure of nodes in a solution tree or workflow based on system requirements, potential issues, etc., which requires significant technical knowledge and domain expertise. The technical solutions described herein, in contrast, provide an intelligent automated approach for suggesting pre-built solution trees or workflows given an input system issue, and are also capable of “suggesting” the next node(s) to be used while a solution tree or workflow is being built (e.g., in the workflow builder interface 603). By learning about issues in real-time and understanding the solution tree or workflow-building process, the technical solutions described herein are able to recommend a most appropriate next step or node (e.g., given the input system issue description or tags and the previous steps or nodes). The technical solutions described herein are thus able to make the process of creating solution trees or workflows more efficient and less prone to errors, potentially making the task more accessible to users without extensive IT experience.

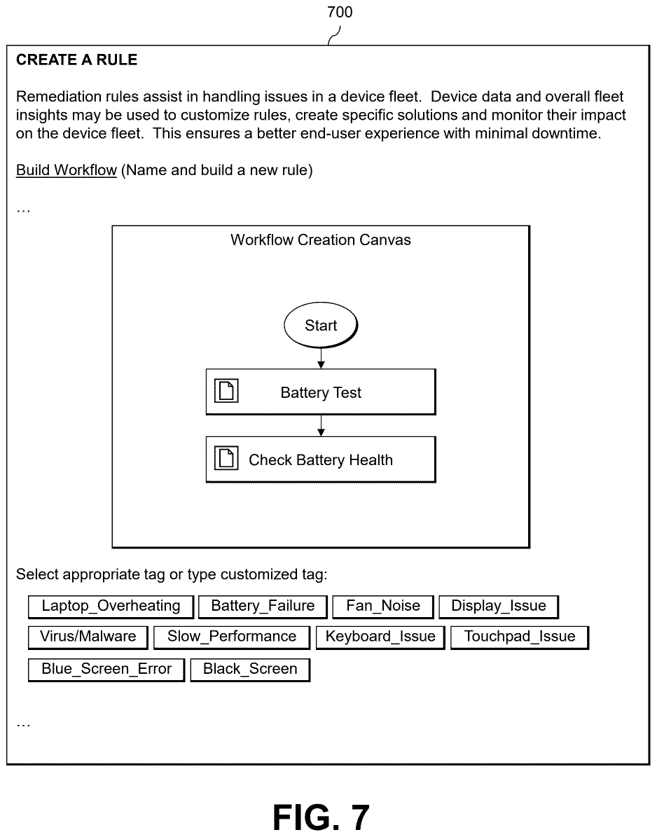

FIG. 7 shows a view 700 of a dashboard interface for creating a solution tree or workflow (e.g., provided by the workflow builder interface 603). Here, a user is able to “create a rule” (e.g., a remediation rule, which provides a solution tree or workflow for assisting in handling issues encountered on IT assets, such as a fleet of devices managed by an IT administrator). The dashboard interface includes an option for building a workflow, where the user can name and build a new remediation rule, with a workflow creation canvas that allows the user to drag-and-drop and edit/connect nodes to build the solution tree or workflow (e.g., beginning with a “start” node and followed by a sequence of nodes each associated with an executable action script). The “nodes” may be selected from a list (not shown in the view 700), where the nodes in the list may be dynamically updated using the content-based recommender. The dashboard interface also presents various tags which may be associated with the solution tree or workflow being built (e.g., which may be determined based on the name of the remediation rule, the nodes which have been selected and made part of the solution tree or workflow in the workflow creation canvas, etc.).

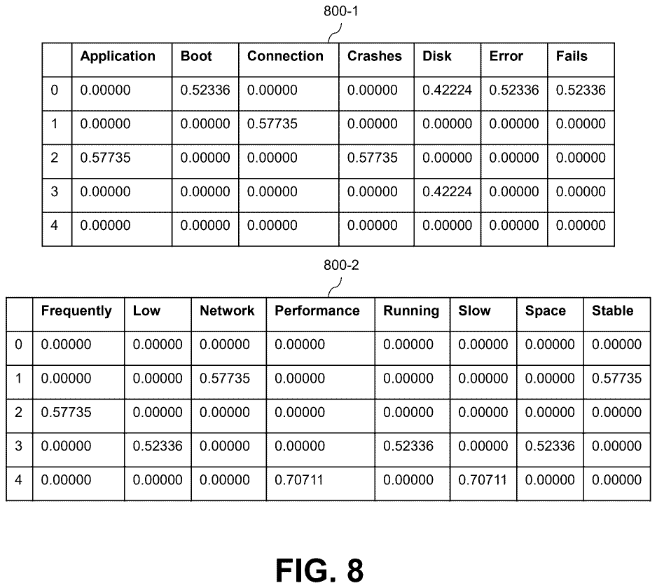

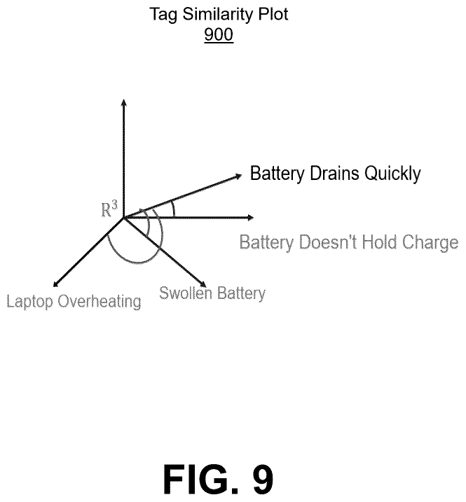

In the specific example of FIG. 7, it is assumed that a user (e.g., an IT administrator) is creating a workflow for solving a battery issue, and the user may tag the workflow with tags such as “Battery_Failure” or “Laptop_Overheating.” The user may also optionally create one or more custom tags to associate with the solution tree or workflow being built. The tags provide a clear and concise way to identify the solution tree or workflow and its purpose, making it easier to understand and reuse the automation process. The tag information subsequently becomes a dependable resource in the next development phases of the automation process. Continuing with the above example, the feedback loop and iterative workflow will now be described. The compiled tags, issue types and execution nodes in the solution tree or workflow are utilized to construct a matrix with TF-IDF scores, illustrated in FIG. 8 as a matrix with two portions 800-1 and 800-2 (collectively, matrix 800). When the user tries to create a solution tree or workflow for “Battery Drains Quickly”, the technical solutions described herein will take this input and do a similarity analysis with respect to existing solution trees or workflows (e.g., “Laptop Overheating,” “Swollen Battery,” “Battery Doesn't Hold Charge,” etc.) having associated matrices of TF-IDF scores. The cosine similarity between the matrix of TF-IDF scores for the input (e.g., “Battery Drains Quickly”) and the matrices of TF-IDF scores for the existing solution trees or workflows is then calculated, to determine the overall similarly of the input issue and the existing solution trees or workflows. This is illustrated by the tag similarity plot 900 of FIG. 9, showing that in this example the input issue “Battery Drains Quickly” is most similar to the existing “Battery Doesn't Hold Charge” solution tree or workflow. These elements come together in a framework that learns and adapts from user interactions while addressing the specific needs of IT processes.

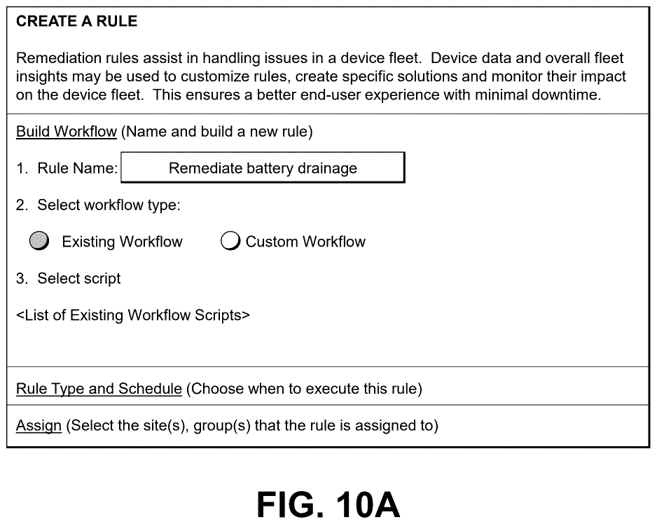

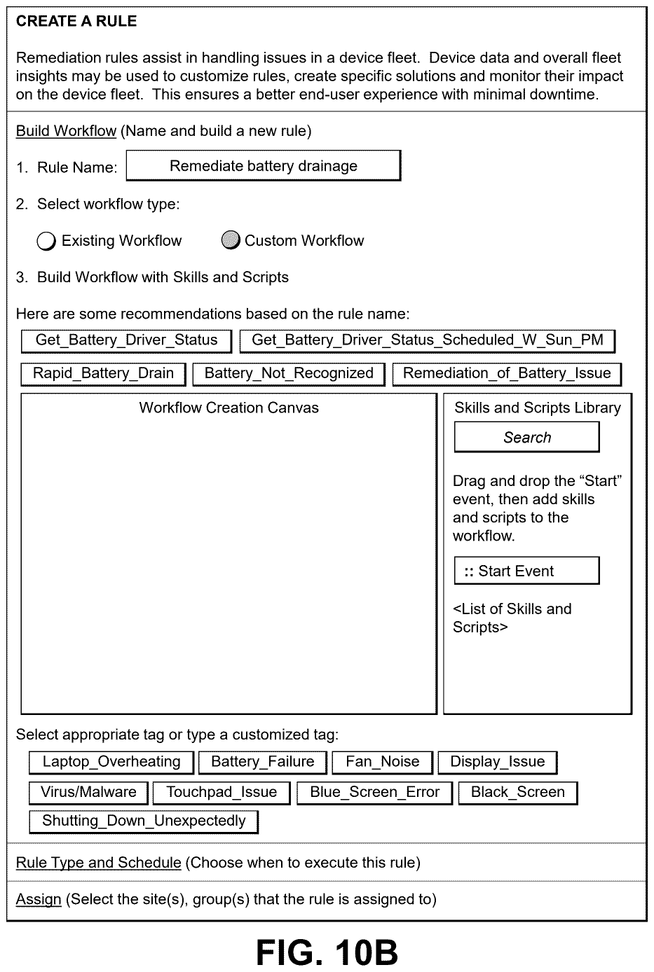

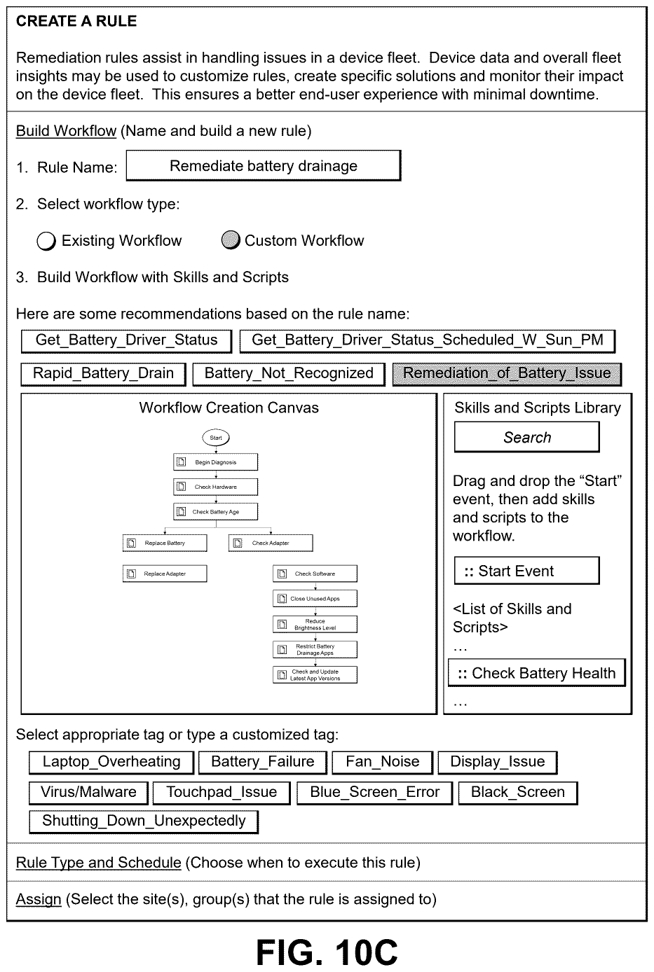

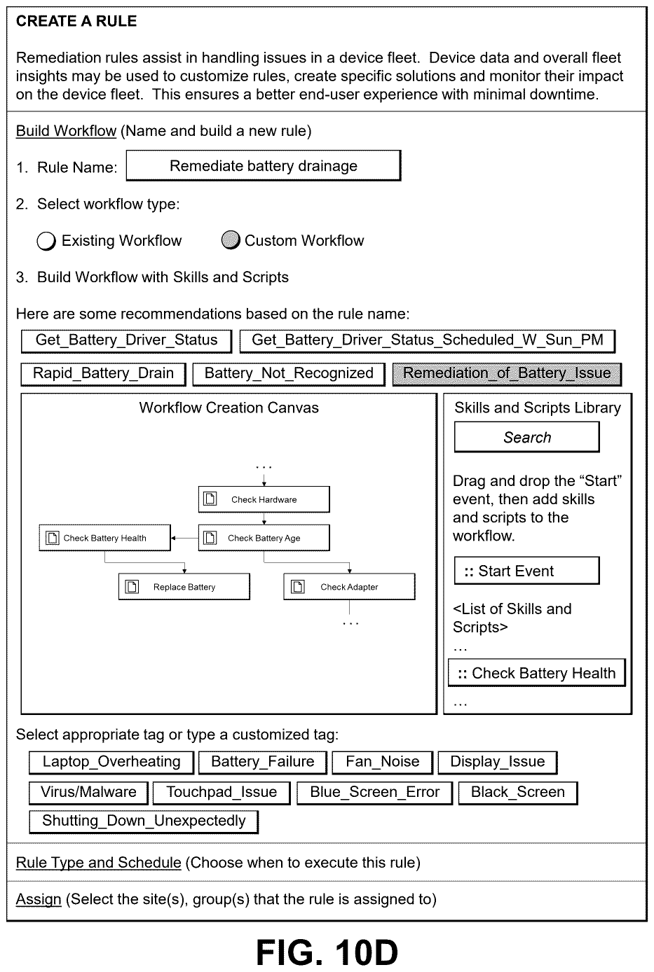

A process flow for creating a solution tree or workflow will now be described with respect to the sequence of views of a GUI (e.g., the workflow builder interface 603) shown in FIGS. 10A-10D. FIG. 10A shows an initial view for creation of a rule, specifically the “build workflow” section where a user inputs a rule name (e.g., “Remediate battery drainage”) and selects a workflow type (e.g., an existing workflow, in which a selection is made from a list of existing workflow scripts, or a custom workflow). The interface also enables specification of a rule type and schedule for the created solution tree or workflow (e.g., when that solution tree or workflow is to be executed) and assigning the created solution tree or workflow (e.g., to one or more specific IT sets, groups of IT devices, etc.). FIG. 10B shows an updated view, where the user changes from the “existing workflow” to the “custom workflow” type. In response, the interface is updated to enable the user to build the custom solution tree or workflow, where some pre-built solution trees or workflows are suggested (e.g., based on a similarity of TF-IDF metrics for the specified rule name and TF-IDF metrics of the existing pre-built solution trees or workflows). A workflow creation canvas is populated, along with a skills and scripts library enabling a user to search skills and scripts, and drag-and-drop skills and scripts to the workflow creation canvas. A set of tags is also populated, which allows the user to associate tags with the solution tree or workflow being built. FIG. 10C shows the interface following the user selection of one of the pre-built solution trees or workflows (e.g., “Remediation_of_Battery_Issue”, shown in FIG. 4) which populates that solution tree or workflow in the workflow creation canvas. FIG. 10D shows the interface following editing of the selected pre-built solution tree or workflow (e.g., by drag-and-dropping the “Check Battery Health” script and connecting that node between the “Check Battery Age” and “Replace Battery” nodes of the pre-built solution tree or workflow). Although not shown, one or more of the tags may be associated with the new custom solution tree or workflow, as well as selection of the rule type and schedule and assignment parameters.

Use of the technical solutions described herein can provide significant improvements and efficiencies in solution tree or workflow creation. For example, the time taken to create a solution tree or workflow may be approximately threefold (e.g., for 10 users utilizing the system from 30 minutes down to 10 minutes, for 20 users utilizing the system from 60 minutes down to 20 minutes, for 50 users utilizing the system from 150 minutes down to 50 minutes). Such efficiency gains may be achieved both for experienced users (e.g., a relative improvement of about three-fourths) and non-experienced users (e.g., a relative improvement of more than two-thirds). The technical solutions described herein thus provide significant improvements relative to conventional approaches for developing solution trees or workflows for various system issues, which are time-consuming and error-prone often leading to incorrect solutions. The technical solutions described herein, in some embodiments, implement a ML-based recommendation system that analyzes historical data of system issues and their resolutions. By learning patterns and relationships, the technical solutions described herein are able to suggest pre-built solution trees or workflows as templates for common issues. The ML-based recommendation system is able to continuously improve based on feedback and the effectiveness of the suggested solution trees or workflows, speeding up the solution tree or workflow creation process (e.g., by 3x or more in some cases). Further, the technical solutions described herein not only enable streamlining of the solution tree or workflow creation process, but also minimize the risk of inaccuracies by providing data-driven recommendations tailor to specific system issues.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based generation of solution trees for issues in an IT infrastructure will now be described in greater detail with reference to FIGS. 11 and 12. Although described in the context of system 100, these platforms may also be used to implement at least portions of other information processing systems in other embodiments.

FIG. 11 shows an example processing platform comprising cloud infrastructure 1100. The cloud infrastructure 1100 comprises a combination of physical and virtual processing resources that may be utilized to implement at least a portion of the information processing system 100 in FIG. 1. The cloud infrastructure 1100 comprises multiple virtual machines (VMs) and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

The cloud infrastructure 1100 further comprises sets of applications 1110-1, 1110-2, . . . 1110-L running on respective ones of the VMs/container sets 1102-1, 1102-2, . . . 1102-L under the control of the virtualization infrastructure 1104. The VMs/container sets 1102 may comprise respective VMs, respective sets of one or more containers, or respective sets of one or more containers running in VMs.

In some implementations of the FIG. 11 embodiment, the VMs/container sets 1102 comprise respective VMs implemented using virtualization infrastructure 1104 that comprises at least one hypervisor. A hypervisor platform may be used to implement a hypervisor within the virtualization infrastructure 1104, where the hypervisor platform has an associated virtual infrastructure management system. The underlying physical machines may comprise one or more distributed processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1100 shown in FIG. 11 may represent at least a portion of one processing platform. Another example of such a processing platform is processing platform 1200 shown in FIG. 12.

The processing platform 1200 in this embodiment comprises a portion of system 100 and includes a plurality of processing devices, denoted 1202-1, 1202-2, 1202-3, . . . 1202-K, which communicate with one another over a network 1204.

The network 1204 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1202-1 in the processing platform 1200 comprises a processor 1210 coupled to a memory 1212.

The processor 1210 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 1212 may comprise random access memory (RAM), read-only memory (ROM), flash memory or other types of memory, in any combination. The memory 1212 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based generation of solution trees for issues in an IT infrastructure as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to obtain a natural language description of one or more issues associated with an information technology infrastructure;
to process, utilizing at least one machine learning model, the natural language description of the one or more issues and at least portions of one or more data structures characterizing content of one or more pre-built solution trees for one or more historical issues;
to select, based at least in part on an output of the at least one machine learning model, at least a portion of at least one of the one or more pre-built solution trees;
to generate a solution tree for the one or more issues utilizing the selected at least a portion of at least one of the one or more pre-built solution trees as a template, the generated solution tree comprising a graphical representation of different potential solutions to the one or more issues and steps for achieving each of the different potential solutions;
to associate the generated solution tree with at least a subset of a plurality of information technology assets of the information technology infrastructure; and
to utilize the generated solution tree for at least one of diagnosing and remediating instances of the one or more issues encountered on the subset of the plurality of information technology assets of the information technology infrastructure.

2. The apparatus of claim 1 wherein the generated solution tree comprises a plurality of nodes and edges connecting the nodes, each of the plurality of nodes representing one of the steps and the edges representing sequences of the steps for achieving the different potential solutions.

3. The apparatus of claim 1 wherein the at least one machine learning model comprises a content-based recommendation model configured to determine similarity metrics between a first set of values associated with the one or more issues and one or more second sets of values for terms associated with the one or more pre-built solution trees.

4. The apparatus of claim 3 wherein the similarity metrics comprise cosine similarity metrics.

5. The apparatus of claim 3 wherein the first and second sets of values comprise term frequency-inverse document frequency (TF-IDF) scores.

6. The apparatus of claim 3 wherein the one or more second sets of values comprise matrices of values characterizing terms in nodes of the one or more pre-built solution trees of the one or more historical issues.

7. The apparatus of claim 3 wherein the first set of values comprises values for terms in one or more semantic tags which are dynamically associated with the one or more issues, and the one or more second sets of values comprise values for terms in one or more semantic tags which are associated with the one or more pre-built solution trees.

8. The apparatus of claim 3 wherein the one or more second sets of values are dynamically updated based at least in part on user feedback regarding effectiveness of the one or more pre-built solution trees in at least one of diagnosing and remediating the one or more historical issues.

9. The apparatus of claim 3 wherein the one or more second sets of values comprise one or more values determined based at least in part on knowledge base articles associated with the one or more historical issues.

10. The apparatus of claim 1 wherein generating the solution tree for the one or more issues comprises utilizing the selected at least a portion of at least one of the one or more pre-built solution trees as the generated solution tree.

11. The apparatus of claim 1 wherein generating the solution tree for the one or more issues utilizing the selected at least a portion of at least one of the one or more pre-built solution trees as a template comprises modifying one or more nodes and edges in the selected at least a portion of at least one of the one or more pre-built solution trees.

12. The apparatus of claim 1 wherein generating the solution tree for the one or more issues utilizing the selected at least a portion of at least one of the one or more pre-built solution trees as a template comprises inserting one or more additional nodes and edges to the selected at least a portion of at least one of the one or more pre-built solution trees.

13. The apparatus of claim 12 wherein the one or more additional nodes and edges are identified utilizing the at least one machine learning model.

14. The apparatus of claim 1 wherein associating the generated solution tree with the subset of the plurality of information technology assets of the information technology infrastructure further comprises specifying a schedule for executing the generated solution tree on the subset of the plurality of information technology assets of the information technology infrastructure.

15. A computer program product comprising a non-transitory processor-readable storage medium having stored therein program code of one or more software programs, wherein the program code when executed by at least one processing device causes the at least one processing device:
to obtain a natural language description of one or more issues associated with an information technology infrastructure;
to process, utilizing at least one machine learning model, the natural language description of the one or more issues and at least portions of one or more data structures characterizing content of one or more pre-built solution trees for one or more historical issues;
to select, based at least in part on an output of the at least one machine learning model, at least a portion of at least one of the one or more pre-built solution trees;
to generate a solution tree for the one or more issues utilizing the selected at least a portion of at least one of the one or more pre-built solution trees as a template, the generated solution tree comprising a graphical representation of different potential solutions to the one or more issues and steps for achieving each of the different potential solutions;
to associate the generated solution tree with at least a subset of a plurality of information technology assets of the information technology infrastructure; and
to utilize the generated solution tree for at least one of diagnosing and remediating instances of the one or more issues encountered on the subset of the plurality of information technology assets of the information technology infrastructure.

16. The computer program product of claim 15 wherein the at least one machine learning model comprises a content-based recommendation model configured to determine similarity metrics between a first set of values associated with the one or more issues and one or more second sets of values for terms associated with the one or more pre-built solution trees.

17. The computer program product of claim 15 wherein generating the solution tree for the one or more issues utilizing the selected at least a portion of at least one of the one or more pre-built solution trees as a template comprises inserting one or more additional nodes and edges to the selected at least a portion of at least one of the one or more pre-built solution trees, the one or more additional nodes and edges are identified utilizing the at least one machine learning model.

18. A method comprising:
obtaining a natural language description of one or more issues associated with an information technology infrastructure;
processing, utilizing at least one machine learning model, the natural language description of the one or more issues and at least portions of one or more data structures characterizing content of one or more pre-built solution trees for one or more historical issues;
selecting, based at least in part on an output of the at least one machine learning model, at least a portion of at least one of the one or more pre-built solution trees;
generating a solution tree for the one or more issues utilizing the selected at least a portion of at least one of the one or more pre-built solution trees as a template, the generated solution tree comprising a graphical representation of different potential solutions to the one or more issues and steps for achieving each of the different potential solutions;
associating the generated solution tree with at least a subset of a plurality of information technology assets of the information technology infrastructure; and
utilizing the generated solution tree for at least one of diagnosing and remediating instances of the one or more issues encountered on the subset of the plurality of information technology assets of the information technology infrastructure;
wherein the method is performed by at least one processing device comprising a processor coupled to a memory.

19. The method of claim 18 wherein the at least one machine learning model comprises a content-based recommendation model configured to determine similarity metrics between a first set of values associated with the one or more issues and one or more second sets of values for terms associated with the one or more pre-built solution trees.

20. The method of claim 18 generating the solution tree for the one or more issues utilizing the selected at least a portion of at least one of the one or more pre-built solution trees as a template comprises inserting one or more additional nodes and edges to the selected at least a portion of at least one of the one or more pre-built solution trees, the one or more additional nodes and edges are identified utilizing the at least one machine learning model.
